(19) United States
(12) Patent Application Publication
(10) Pub. No.: US 2014/0278974 A1
(43) Pub. Date: Sep. 18, 2014

(54) Digital Body Language

(71) Applicant: Matthew Standish, Woodinville, WA (US)

(72) Inventor: Matthew Standish, Woodinville, WA (US)

(21) Appl. No.: 13/844,698

(22) Filed: Mar. 15, 2013

(51) Int. Cl. G06Q 30/02; G06Q 50/00

(52) U.S. Cl. CPC G06Q 30/0255; G06Q 50/01
USPC 705/14.53

(57) ABSTRACT

This application discloses, among other things, techniques for assessing Digital Body Language, which may aggregate structured and unstructured data from multiple sources, automatically abstracting data into easy-to-use 360-degree graphic representations of individuals, groups, events and communities called “Personas.” Personas may be analyzed to identify “demand signals,” which may indicate real-time intent and interest for specific brands, products and services. When demand signals arise, marketers may be empowered to authentically engage with these individuals and prospect clusters by delivering personalized offers via their preferred digital channels. Through a better understanding of consumer purchase intent, marketers may be enabled to initiate more timely and relevant interactions, which may result in improved revenue conversion and return-on-investment (ROI).

### FIELD

This disclosure relates to Digital Body Language.

### BACKGROUND

Traditional marketing analysis often requires Business Intelligence and CRM systems, which are expensive, complex and often take upwards of 18 months to onboard. These systems also lack multi-channel views of customer behaviors linked to demand and are solely focused on providing 30-60-90 day reports. Marketing and Customer Insights organizations often found these systems lacking when it came to delivering actionable information about customers to internal constituents like sales and marketing. Tools focused exclusively on social media also fell significantly short, providing reports on things like brand sentiment but failing to contextualize or bring social data to life in a meaningful and relevant way.

### SUMMARY

This application discloses, among other things, techniques for assessing Digital Body Language, which may aggregate structured and unstructured data from multiple sources, automatically abstracting data into easy-to-use 360-degree graphic representations of individuals, groups, events and communities called “Personas.” Personas may be analyzed to identify Demand Signals, (DS) which may indicate real-time intent and interest for specific brands, products and services. When Demand Signals arise, marketers may be empowered to authentically engage with these individuals and prospect clusters by delivering personalized offers via their preferred digital channels. Through a better understanding of consumer purchase intent, marketers may be enabled to initiate more timely and relevant interactions, which may result in improved revenue conversion and return-on-investment (ROI). One embodiment may be referred to as a Demand Exchange Platform.

By analyzing demand signals with high-context machine-learning algorithms, consumers' intent to purchase may be identified, which may enable enterprises to reach out with highly targeted offers that may instantly influence purchase decisions. For example, a CADILLAC® dealership that sends out a low Annual Percentage Rate offer to thousands of prospects using a traditional tactic like email is likely to miss the mark with the vast majority of recipients—either because they are no longer in the market for a car purchase, or were simply not interested in a Cadillac.

Using Digital Body Language, that same dealership may benefit from real-time information and analytics identifying prospects that are actually considering a CADILLAC® CTS-V® based on their mobile “app” research on zero to sixty (0-60) mile per hour acceleration and solicitation of advice from their social network(s).

Data may be sourced from social media channels, client mobile applications and CRM systems. This may provide real-time information about what consumers are doing, considering and purchasing. This channel agnostic approach to data collection may eliminate the need to invest in channel specific tools, and may paint a more accurate picture of consumer demand for particular goods and services.

Multiple data points may be consolidated into singular highly contextual consumer views for individuals, groups, events and communities called “Personas.” Personas may contain and may continually update privacy, viral score, brand consideration, and historical and potential revenue contribution information. Consumer “demand signals” within Personas may be analyzed, which may determine real-time intent. Personas may allow a marketer to sense shifts in market perception and understand the real-time demand curve for their company and its offerings.

Predictive analytics and propensity to buy algorithms may be applied to Personas, which may determine the highest revenue potential prospects for each client. This information may allow marketers to focus quickly on the most valuable prospects relative to their business objectives, which may lead to increased revenue and ROI.

Prospects may be recommended for client interaction pre-aligned with available offers.

The status of customer interactions may be continually measured, tracked and reported, which may help enterprise digital marketers measure campaign effectiveness and ROI.

### BRIEF DESCRIPTION OF THE DRAWINGS

FIG. 1 illustrates a system capable of supporting Digital Body Language according to one embodiment.

FIG. 2 is a block diagram showing a data collected and analysis output according to one embodiment.

FIG. 3 is a flow chart showing an example use case according to one embodiment.

FIG. 4 illustrates a component diagram of a computing device according to one embodiment.

### DETAILED DESCRIPTION

FIG. 1 illustrates a system capable of supporting Digital Body Language according to one embodiment. User Device 110 may include a processor, memory and computer readable storage media.

Network 120 may include Wi-Fi, cellular data access methods, such as 3G or 4GLTE, Bluetooth, NFC, the internet, local area networks, wide area networks, or any combination of these or other means of providing data transfer capabilities. In one embodiment, Network 120 may comprise Ethernet connectivity. In another embodiment, Network 120 may comprise fiber optic connections.

Server 130 may include one or more computers, and may serve a number of roles. Servers 130 may be conventionally constructed, or may be of a special purpose design for processing data for Digital Body Language. One skilled in the art will recognize that Server 130 may be of many different designs and may have different capabilities.

Server 140 may include one or more computers, and may serve a number of roles. Servers 130 may be conventionally constructed, or may be of a special purpose design for its purpose. One skilled in the art will recognize that Server 130 may be of many different designs and may have different capabilities.

User Device 110 may be used to update information stored on a social network, for example FACEBOOK®, TWITTER®, or PINTEREST®. Server 140 may be used to host a social network, storing and retrieving information shared by a user of User Device 110. Server 140 may also host a search engine, which may allow a user of User Device 110 to perform searches of enterprise data, web data, or other types of data. Server 130 may analyze data retrieved from Server 140 and may analyze the retrieved data to analyze Digital Body Language.

Digital Body Language may provide cues to indicate whether a person has a propensity to buy a product. By identifying that a person is interested in purchasing the product and analyzing various aspects of the person's online behavior, an effective strategy may be determined for converting the propensity to buy into a sale for the product.

FIG. 2 is a block diagram showing a data collected according to one embodiment. Server 130 may collect and analyze data to determine a Propensity to Buy. Data Server 130 may collect includes Brand Mentions 210 (BM), Product Mentions 220 (PM), Active Audience 230 (AA), and Total Audience 240 (TA). Brand Mentions 210 may indicate a number of the times a user mentions a brand on a social network, and Product Mentions 220 may indicate a similar metric for mentions of a product. Active Audience 230 may reflect people who have made posts including Brand Mentions 210 or Product Mentions 220 over a specified time period, for example over the past week, or over the past three days. Total Audience 240 may count all people who made posts including Brand Mentions 210 or Product Mentions 220 at any time. Search Interests 260 (SI) may measure how often a brand or product is searched for on one or more search engines. One having skill in the art will recognize that other metrics may be of interest and may be used when calculating a propensity to buy.

Dictionary of Adverbs and Adjectives 270 (DADA) may include words that indicate a positive or negative feeling toward a brand or product. For example, a post stating a BMW® M3® is the ultimate driving machine would indicate a positive feeling toward that product. Dictionary of Adverbs and Adjectives 270 may contain a list of 15 to 20 words, for example, which may be measure Emotion 280 (E), which may be an indicator of a person's emotional state. For example, Emotion 280 may indicate Excited, Happy, Comfortable, Unhappy, or Upset, which may be assigned numerical values and used in formulas. In another embodiment, Emotion 280 may be used to assess a feeling over a number of people.

Viral Score 250 (V) may be a calculation which may later be used in calculating a Demand Signal, which may be performed on Server 130, which may be calculated as:

$$V = \frac{T A + 2.5 ( AA )}{T A}$$

A Demand Signal may be an indicator of a target group of consumers who may have a high propensity to buy. Other calculations may be performed to provide other metrics which may be used to calculate a Demand Signal.

A Demand Signal may be derived from a number of characteristics including, for example, Search Interest (SI), a number of searches for a Brand or Product; Brand Mentions; Viral Score; Total Audience; Active Audience (which may include people who made posts or other updates within a specified time period); location; and Emotions; as well as adjectives, adverbs and verbs that are used to modify a post mentioning a Brand, Product or Service. The Demand Signal may be attached to a Persona (Consumer/Group/Event) and it may be ranked based on importance in a Demand Exchange Platform, where it may be used as a qualified lead for the Brand. The Propensity of that consumer, group or event is further ranked by their propensity to buy your product feeds the Demand Signal, however, the two can be mutually exclusive. A Demand Signal may fall between an upper and lower control limit as defined by the Demand Exchange Platform based on an outlined algorithm that may create an event or may recommended an action for a brand to understand whether to prioritize an offer based on Brand Mentions, Audience, Propensity to Buy, Actual Demand Score, Viral Score, Potential Revenue and Active Audience. According to one embodiment:

DS=2(SI)+E+DADVJ+BM+2(PM).

Once demand identification is created the Demand Exchange may match current brand offers to demand signals based on the scoring and ranking of Demand Signal, Digital Body Language Score, which may lead to recommended campaigns and offers.

FIG. 3 is a flow chart showing an example use case according to one embodiment. Using APIs to monitor social network posts and other sources of data, Brand Mentions or Product Mentions may be detected by a Digital Body Language system in Listen for Mentions 310. If Brand Mentions or Product Mentions are detected, a user making the posts may be tracked, and data collected to Create Persona 320. A Persona may be a profile, containing information about the user, including, for example, location, gender, or social influence, such as number of friends or followers. By Collecting Longitudinal Persona Data 330, the profile may include counts of times the user does Brand Mentions, Product Mentions, how many people share information from the user, which adverbs and adjectives the user uses when describing the Brand and Product, and other metrics. If a user is detected making Brand Mentions or Product Mentions Have User 340 may determine if the user is already known by the Digital Body Language system; if No, Add User 350 may add the user to the Digital Body Language system. For example, if a first user had posted on FACEBOOK® and mentioned a particular product, and the Digital Body Language system later detects a second user on TWITTER® mentioning the same product, the Digital Body Language may try to determine if the second user is the same person as the first user. If Yes the Digital Body Language system may Analyze Digital Body Language 360. Various metrics collected during Collect Longitudinal Persona Data 330 may be used to identify and rank users with a propensity to buy scale. A Marketing Plan may then be Developed 370 to target users matching personas with a high propensity to buy.

Propensity to Buy (P2B) may be calculated as:

P2B=BM+PM+AA+SI+V+DS

Personas may also be created for a group. For example, a group of hobby railroad enthusiasts may be profiled to determine a persona for which members are appropriate to invite to an event. Events may also be profiled and personas identified. For example, a classic car auction house may target people who are interested in buying a 1969 CHEVELLE® SS 396 if they have one for sale. A Persona may be identified and people who meet the persona profile may be invited to an auction.

One having skill in the art will recognize that personas may be used for different purposes, and that different metrics may be useful for creating different personas.

Marketing Plans may include Offers and Campaigns. A Campaign may include one or more Offers. An Offer may be based on segmentation, demographics, geo-location, loyalty, or other attributes. A Customer base may be segmented by various attributes, including customer behaviors, usage patterns, preferences, or other attributes.

An Offer may be delivered through email, social media, mobile communications such as SMS or MMS, web sites, floating toolbars, dedicated applications, or other means.

One having skill in the art will recognize that Offers may be based upon other attributes or analytics, and that an offer may be delivered through various means.

FIG. 4 illustrates a component diagram of a computing device according to one embodiment. The computing device (1300) can be utilized to implement one or more computing devices, computer processes, or software modules described herein. In one example, the computing device (1300) can be utilized to process calculations, execute instructions, receive and transmit digital signals. In another example, the computing device (1300) can be utilized to process calculations, execute instructions, receive and transmit digital signals, receive and transmit search queries, and hypertext, compile computer code as required by a Server 130 or a User Device 110. The computing device (1300) can be any general or special purpose computer now known or to become known capable of performing the steps and/or performing the functions described herein, either in software, hardware, firmware, or a combination thereof.

In its most basic configuration, computing device (1300) typically includes at least one central processing unit (CPU) (1302) and memory (1304). Depending on the exact configuration and type of computing device, memory (1304) may be volatile (such as RAM), non-volatile (such as ROM, flash memory, etc.) or some combination of the two. Additionally, computing device (1300) may also have additional features/functionality. For example, computing device (1300) may include multiple CPU's. The described methods may be executed in any manner by any processing unit in computing device (1300). For example, the described process may be executed by both multiple CPU's in parallel.

Computing device (1300) may also include additional storage (removable and/or non-removable) including, but not limited to, magnetic or optical disks or tape. Such additional storage is illustrated in FIG. 8 by storage (1306). Computer readable storage media includes volatile and nonvolatile, removable and non-removable media implemented in any method or technology for storage of information such as computer readable instructions, data structures, program modules or other data. Memory (1304) and storage (1306) are all examples of computer storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device (1300). Computer readable storage media does not include transient signals. Any such computer readable storage media may be part of computing device (1300).

Computing device (1300) may also contain communications device(s) (1312) that allow the device to communicate with other devices. Communications device(s) (1312) is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device (1300) may also have input device(s) (1310) such as keyboard, mouse, pen, voice input device, touch input device, etc. Output device(s) (1308) such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

Additionally, the illustrated operations in the description show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments of the invention has been presented for the purposes of illustration and description. It is not intended to be exhaustive or to limit the invention to the precise form disclosed. The above specification, examples and data provide a complete description of the manufacture and use of the invention. Because many embodiments of the invention can be made without departing from the spirit and scope of the invention, the invention resides in the claims hereinafter appended.

1. A computer operable method, comprising:
listening for data from a social network interface;
detecting a mention from the data, the mention being for a product, the mention being from a user;
creating a persona for the user;
collecting data about the persona over time;
evaluating a propensity to buy the product for the persona based upon the collected data;
determining the persona's propensity to buy is above a threshold;
developing a marketing strategy to target the persona; and
marketing to the user using the developed strategy.

2. The method of claim 1, wherein developing a marketing strategy further comprises matching an existing marketing campaign to the persona.

3. The method of claim 1 wherein the creating a persona further comprises:
determining a value for a metric; and
associating the value for the metric with the user.

4. A system, comprising:
a processor;
a memory coupled to the processor;
computer operable components, comprising:
a listening component, configured to listen to social networking data from a social network interface;
a mention detection component, configured to detect a mention of a product from the social networking data and identify a person who posted the mention;
a persona creating component, configured to create a persona for the person;
a persona data collecting component, configured to collect data about the persona over time;
a propensity to buy rating component, configured to rate a propensity to buy for the persona;
a value comparing component, configured to determine if the propensity to buy rating exceeds a threshold rating; and
a marketing strategy selection component, configured to select a marketing strategy to use to target the persona.

5. A computer readable storage media containing instructions therein which, when executed by a processor, perform a method comprising:
listening for data from a social network interface;
detecting a mention from the data, the mention being for a product, the mention being from a user;
creating a persona for the user;
collecting data about the persona over time;
evaluating a propensity to buy the product for the persona based upon the collected data;
determining the persona's propensity to buy is above a threshold;
developing a marketing strategy to target the persona; and
marketing to the user using the developed strategy.

6. The method of claim 5, wherein developing a marketing strategy further comprises matching an existing marketing campaign to the persona.

7. The method of claim 5, wherein the creating a persona further comprises:
determining a value for a metric; and
associating the value for the metric with the user.
